(19) United States
(12) Patent Application Publication
(10) Pub. No.: US 2008/0133273 A1
(43) Pub. Date: Jun. 5, 2008

(54) System and method for sharing medical information

(76) Inventor: Philip Marshall, Portland, OR (US)

Correspondence Address: WILMERHALE/BOSTON, 60 STATE STREET, BOSTON, MA, 02109, US

(21) Appl. No.: 11/633,155

(22) Filed: Dec. 4, 2006

(51) Int. Cl. G06Q 50/00

(52) U.S. Cl. 705/3

(57) ABSTRACT

Systems and methods for sharing medical information are provided. More particularly, collection and exchange of medical information across disparate health care systems into a personal health record is provided. Access to and data exchange with the personal health records is provided through a health record access ID. The health care organization or health care institution authenticates a user after receiving a health record access ID and then provides personal information known about the user to access the personal health record and initiate a data exchange. Further, secure messaging from a user to a health care professional is provided. The secure messaging can utilize the health care provider's system to assist in the delivery of the message.

### FIELD OF THE INVENTION

The present invention relates to a system and method for sharing medical information. More particularly, users can share and exchange health information with various institutions and organizations of their choosing and across disparate systems.

### DESCRIPTION OF RELATED ART

Health care professionals use medical information to treat and diagnose patients. Full and accurate knowledge of medical information such as the patient's prior medical history, current medications, drug allergies, and recent medical test results allows health care professionals to diagnose the patient more accurately and more quickly. Medical information also provides a record that allows health care professionals to ascertain the state of a patient. Some health care institutions and health care organizations have moved to electronic health record (EHR) systems, which replace a paper file system. Other health care institutions and health care organizations have moved from paper files to a combination of paper and electronic files.

Electronic systems may be used for a variety of reasons such as billing, appointment scheduling, sending messages between health care professionals on the system, and storing medical information. The electronic files may be stored in various formats and on various computer systems by the health care institutions and health care organizations. Converters exist that translate information from one format to another format so that electronic files can be migrated from one computer system to another computer system. Additionally, paper files can be created from the electronic files by printing the information and inserting a paper copy into a folder for more portable use.

### SUMMARY OF SOME EMBODIMENTS

Systems and methods are provided for consumer-driven collection and exchange of medical information across disparate health care systems with multiple health care providers. A health record access ID can provide access to and data exchange of a user's medical information. The health record access ID creates a portable personal health record that can be used, for example, in emergency situations or when visiting a new health care provider. Secure messaging from a user to a health care professional is also provided so a user can communicate through a web-based interface with a health care professional. The secure messaging can utilize the health care provider's system to assist in the delivery of the message.

In one aspect, a method for sharing and exchanging medical information in a personal health record includes receiving registration information from a user in response to receiving registration information from the user, creating a unique health record access ID, associating the unique health record access ID with the personal health record so that the unique health record access ID identifies the personal health record, through a network interface receiving from a third party the unique health record access ID and at least one piece of personal information identifying the user, and providing access to the personal health record that is identified by the unique health record access ID.

In another aspect, a system for sharing and exchanging medical information in a personal health record includes a web-based interface receiving registration information from a user, a server accessible through the web-based interface and coupled to at least one storage where personal health records reside, a CPU residing in the server in communication with the web-based interface that in response to receiving registration information from the user, creates a unique health record access ID and associates the unique health record access ID with the personal health record so that the unique health record access ID identifies the personal health record, and the web-based interface receiving from a third party the unique health record access ID and at least one piece of personal information identifying the user and providing access to the personal health record that is identified by the unique health record access ID.

In yet another aspect, a method for sharing and exchanging medical information from a plurality of users includes receiving from any one user in the plurality of users registration information in response to receiving registration information from the any one user in the plurality of users, creating a unique health record access ID, associating the unique health record access ID with a personal health record of the any one user in the plurality of users so that the unique health record access ID identifies the personal health record in a plurality of personal health records, through a network interface receiving from a third party the unique health record access ID and at least one piece of personal information identifying the any one user in the plurality of users, and providing access to the personal health record that is identified by the unique health record access ID.

### BRIEF DESCRIPTION OF THE DRAWINGS

FIG. 1 shows schematically a computer system operating environment;

FIG. 2 shows a health record access ID management display;

FIG. 2A shows an ID card;

FIG. 3 shows a print, fax, or send record display;

FIG. 3A shows an abbreviated personal health record summary;

FIG. 4 shows a personal health record home display;

FIG. 5 shows a personal health record edit display;

FIG. 6 shows a medications display;

FIG. 7 shows a medication edit display;

FIG. 8 shows a test results and trackers screen;

FIG. 9 shows a family history display;

FIG. 10 shows a social history display;

FIG. 11 schematically shows interfaces to personal health records;

FIG. 12 shows a login display and a personal health records display;

FIG. 13 shows a data exchange login display;

FIG. 14 schematically shows a data exchange procedure;

FIG. 15 shows a process diagram for sharing an ID and for exchanging data;

FIG. 16 shows a process diagram for updating personal health information; and

FIG. 17 shows a process diagram for messaging a health care professional.

### DETAILED DESCRIPTION OF SOME EMBODIMENTS OF THE INVENTION

The described embodiment is a medical information system for sharing health information. In the described embodiment, a user directs the medical information system to generate an alpha-numeric ID, either automatically or manually to associate with his or her personal health record and controls access by this ID to the personal health record through a web-based internet interface. The user, who is any individual who registers with the medical information system, provides this ID to a health care provider such as a health care institution or a health care organization (e.g., a health plan, an employer health program, or a regional health information organization) so that the health care provider can access the user's personal health record. Personal health records are a collection of various types of medical information for a particular patient. When the health care provider uses the ID to access the user's personal health record, the web-based interface prompts the health care provider with questions about the user's personal information. The health care provider answers these questions with information on record about the user to gain access to and exchange with medical information stored in the personal health records. The ID allows to user to facilitate data exchange between multiple disparate systems and the medical information stored on these disparate health care systems. The ID creates a portable personal health record that can be used, for example, in emergency situations or when visiting a new health care provider.

The described embodiment, a medical information system, allows users to control their medical information and to share their medical information across disparate health care provider systems. The user's medical information is gathered into personal health records. Medical information can be exchanged over the Internet through an interface. The exchange can involve uploading information from the health provider's system to the personal health records, or can involve downloading information from the personal health records to the health care provider's system. Uploading and downloading is facilitated by a health record access ID. The user may control uploading and downloading by user selected health care professionals or providers. The downloading permits a user to provide a new health care provider, and specifically a health care professional, with relevant medical information. The exchange can reach across disparate systems by converting medical information from one standard or format used by a health care provider to one used to store personal health records. Further, the medical information system facilitates exchange of both clinical data and secure messages from a user to a selected health care professional, and vice versa. In describing this medical information system an example of equipment involved in creating the system is explained, then various aspects of a personal health record are described. Finally, interfaces to the personal health record and data exchange including secure messaging are detailed.

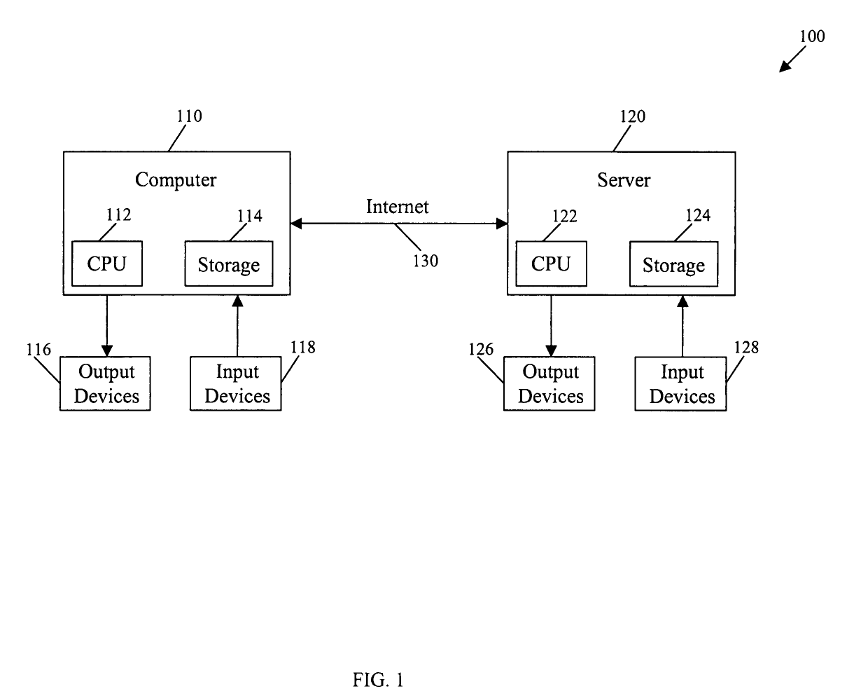

FIG. 1 depicts an operating environment 110 for the medical information system. Operating environment 110 includes a computer 110, a server 120, and an Internet connection 130. Computer 110 further comprises a CPU 112, storage 114, output devices 116, and input devices 118. In operation, computer 110 runs software, such as an operating system and web browser, which are processed by CPU 112 and stored in storage 114. The software includes information that is displayed or recorded on output devices 116, and inputted or modified by input devices 118. Users access their personal health records, add to or modify their personal health records, and create a unique health record access ID for sharing access and exchanging medical information with health care providers through a web browser interface on computer 110. Health care providers use a web browser interface on computer 110 to access the user's personal health records when provided with a health record access ID and exchange medical information with the personal health records provided computer 100 also stores medical information.

The computer 110 provides access through an Internet connection 130 to server 120. Server 120 further includes a CPU 122, storage 124, output devices 126, and input devices 128. The CPU 122 processes incoming requests received over Internet connection 130 and accesses personal health records residing in storage. Upon verifying a health record access ID and at least one piece of personal information provided at computer 110, server 120 provides access to personal health records, initiates an exchange of data with computer 110, and/or allows management of the personal health records and associated access through an interface. The server 120 also parses medical information received from computer 110, such as when computer 110 is a health care provider uploading data, and converts the data into a format for storage in a personal health record. Computer 110 and server 120 communicate over the Internet connection 130 using an IP protocol or any other applicable communication method.

The medical information system provides a registration for individuals to create a health record access ID and a personal health record. The user may opt to not create a health record access ID, but whether the user creates one or not, a set of questions and answers is created to manage access to the user's profile. The questions are used to validate the user when access to the profile or the personal health records is desired. The questions selected by the user may also be used when controlling health care provider access and other third party access to the personal health records. The medical information system permits a user to associate other health record access IDs with an existing profile and personal health record. This is accomplished by identifying a health record access ID that the user desires to re-associate and the exiting health record access ID profile to which the user desires to associate. The user is prompted with the questions from the existing health record access ID registration before the association is allowed. The user's profile can be more expansive than the personal health record and the associated health record access ID. Other services and other portals to a user's profile may be provided.

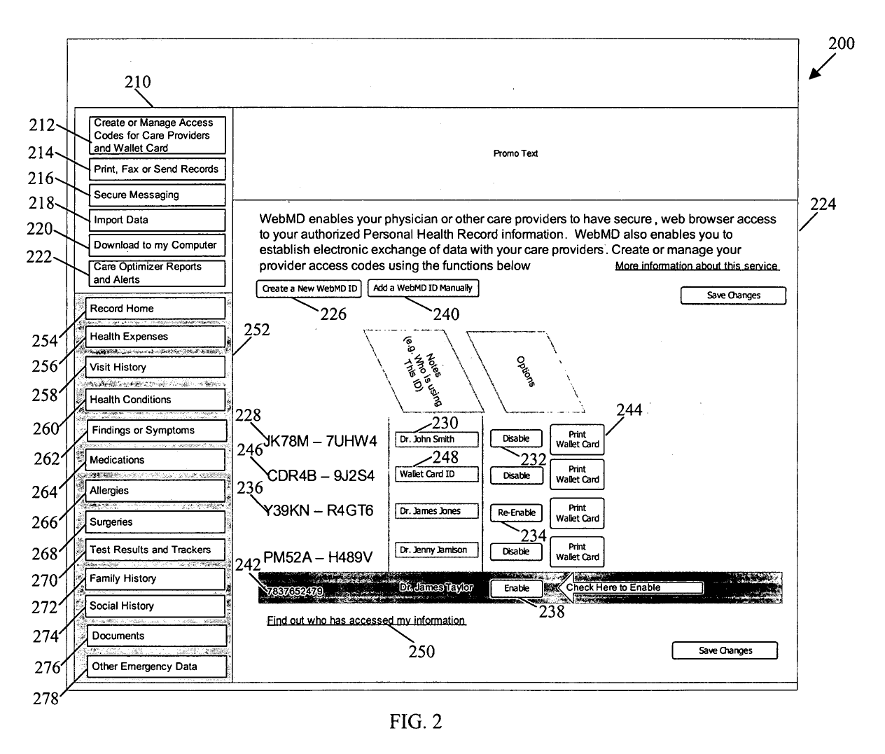

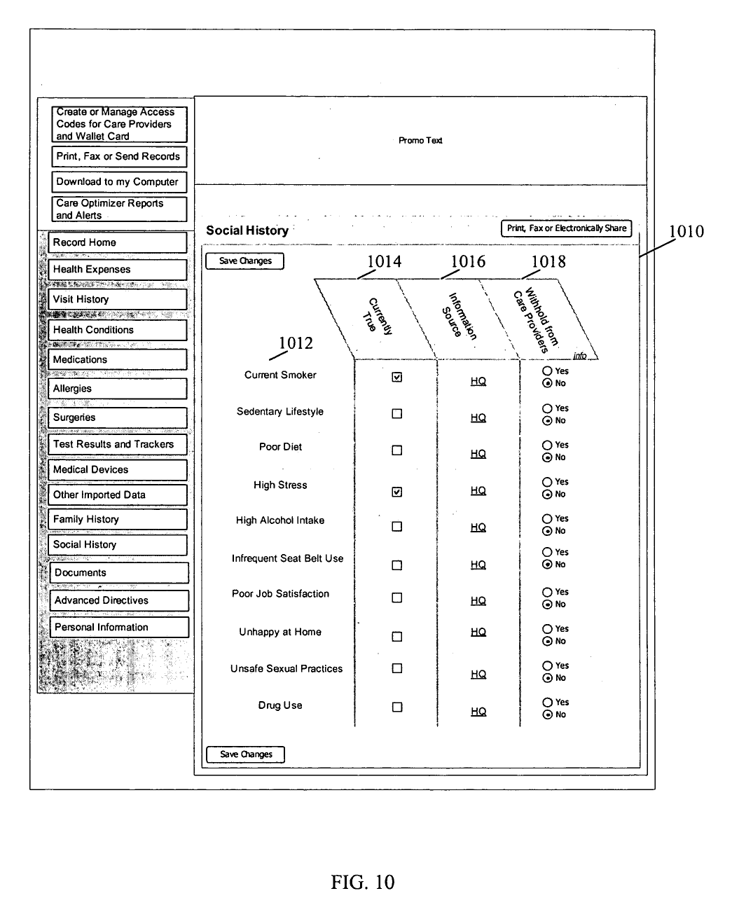

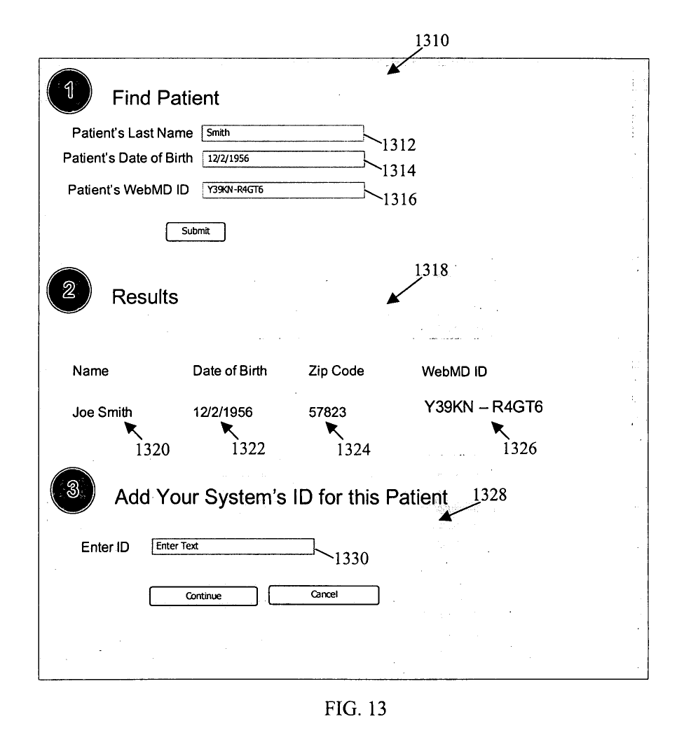

FIG. 2 shows a screenshot 200 of an interface to manage access and modify personal health records. A personal health record management section 210 presents options to create or manage access 212, print, fax, or send records 214, message securely 216, import data 218, download information 220, and setup reports and alerts 222. A create or manage access screen 212 is shown in section 224. Section 224 provides an option for creating a new health record access ID 226. This health record access ID is automatically generated using a combination of alpha-numeric characters that is unique for a user across the medical information system. An example of an automatically generated health record access ID is shown by health record access ID 228. In this example, the health record access ID 228 is associated by the user with Dr. John Smith 230, and can be used to provide Dr. John Smith with access to personal health records and provide for a data exchange of personal health records between the medical information system and Dr. John Smith's system. The data exchange is further explained below with reference to FIGS. 11 and 14, for example.

Health record access ID 228 is associated with aspects of the personal health record selected by the user. The user selects the amount of access provided to third parties through a particular health record access ID. For example, health record access ID 228 may provide access to records over a certain data range, to records relating to certain medical conditions, or to records relating to specified health care providers. Other restrictions on access may also be added depending on the user's interests, such as a time period in which the access using that health record access ID may be available. The user may create more than one health record access ID as is shown as is shown in section 224. Each health record access ID may be associated with the aspects of the personal health record selected by the user. A disable option 232 allows a user to completely stop access to medical information through health record access ID 228. The disable option 232 can be used, for example, if a health record access ID lost or stolen. While login access through a disabled health record access ID is stopped, the configuration information of the medical access ID is retained. A re-enable option 234 allows a user to reactivate a health record access ID or create a new health record access ID to replace health record access ID 236 while retaining configuration settings associated with health record access ID 236. An enable option 238 allows a user to activate a health record access ID that was newly created for use.

A health record access ID can be manually created through option 240. When using option 240, a user selects a ten-digit alpha-numeric character sequence and this sequence is checked for uniqueness. If the sequence is found to be unique, health record access ID 242 is added. The manual creation through option 240 also provides a user with the ability to enter in a unique health record access ID that has been pre-generated. For example, the health record access ID 242 is activated by using the enable option 238. When setting up a health record access ID through option 226 or 240, a user can be prompted to enter any access restrictions or otherwise configure the health record access ID before the creation process is completed. A print wallet card option 244 becomes available after a health record access ID is enabled. The print wallet card option 244 allows a user to print a card 210A that includes health record access ID 212A and other information as shown in FIG. 2A. The card 210A includes the health record access ID 212A selected by the user in FIG. 2 when choosing the “Print Wallet Card” option. The card includes the user's name 212A and a universal relay link from which the personal health records can be accessed. A health record access ID 246 can be chosen to be a wallet card ID 248 that is used in emergency situations or when a user visits new health care providers. Option 250 allows a user to check who has accessed the personal health records associated with a health record access ID. Selecting option 250 provides a screen displaying, for example, a date, a time of access, an action performed (e.g., access, exchange of data), the health record access ID used, and health care provider name. If any suspicious activity is found, the user can deactivate the health record access ID with disable option 232.

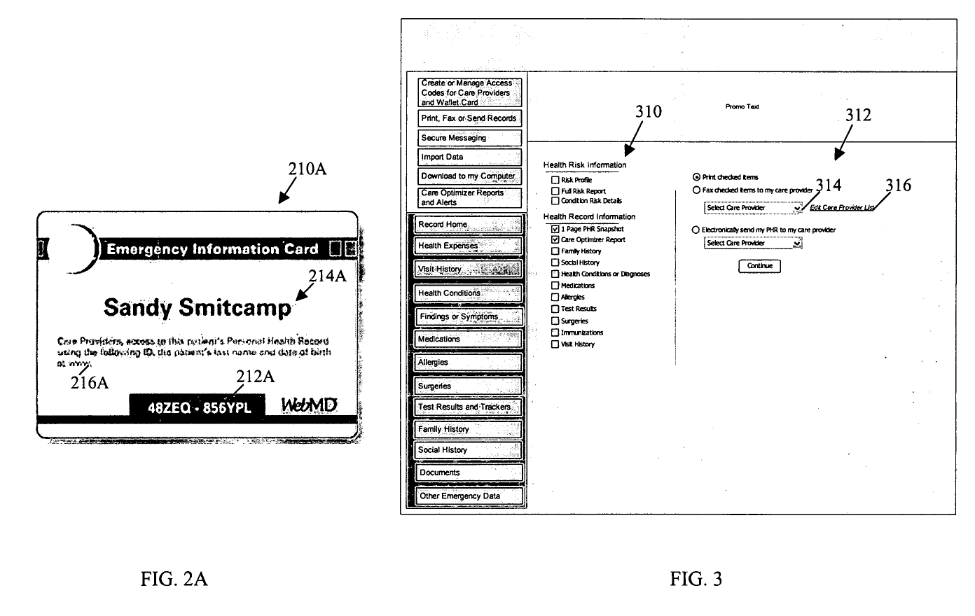

The print, fax, or send records option 214 permits users to output selected portions of their personal health records. The user can select all of the personal health record information residing on server 120 (FIG. 1) for output or select portions of the personal health record information based on date ranges, medical care provider, and type of record for example. The medical information system outputs the personal health information by printing, faxing, or electronically sending (e.g., initiating a file transfer). FIG. 3 depicts a screenshot of print, fax, or send records option 214. The user is prompted to select types of information 310 to print, fax, or electronically send 312. A health care provider pick list 314 is provided for faxing or electronically sending the information. The pick list 314 includes information regarding health care providers that the user has entered and/or health care providers that have been involved in a data exchange. An edit health care provider list option 316 is provided so that the user can add new health care providers or update health care providers already in pick list 314. FIG. 3A depicts a sample personal health record summary 300A that can be generated by a user with the print, fax, or send records option 214. As is shown in FIG. 3A, the user can select the types of personal health record information they would like displayed in the summary report.

The messaging securely option 216 allows a user to contact a health care professional in a secure environment. Some electronic health record (EHR) systems provide for secure messaging between health care professionals in the same practice or on the same system, but do not allow for communication outside of the EHR system. The messaging securely option 216 provides users with the ability to send a message into the EHR system of their health care provider and to their health care professional. Thus, messaging between systems is enabled. The messaging securely screen includes components such as an inbox, a sent items, a draft items, an archive, and a compose functionality for example. The compose functionality provides a list of health care providers to which a user can send a free-text message. During composition, the user may choose to save the message. The message is saved as a draft in the draft items component. The user can also choose to receive email notification when a secure message is received. The email notification includes a link with a directed login to the messaging securely option 216. The health record access ID may be used as one type of identifier that helps facilitate the exchange of messages.

The import data option 218 permits a user to allow a health care provider to upload and download personal health records without a health record access ID. The user is notified in a messaging securely option 216 that the health care provider needs to be authorized. An email notification can be sent with a link directed to the messaging securely option 216. Upon authorizing the health care provider, the user may choose to disable further access by the health care provider, which disallows additional imports from that health care provider. The user may also select to no longer be notified of an exchange request when an import is disallowed. If a health care provider that has not yet been authorized tries to import data to a user, the imported data is temporarily stored on server 120 (FIG. 1). The imported data is temporarily stored until a decision is made or until a specified time period elapses. If a decision is made to authorize, the imported data is released into the personal health record.

The download information option 220 allows a user to store a copy of personal health record information locally. The user can select what information to copy if copying all personal health information is not desired. The personal health information is copied to computer storage 114 (FIG. 1) or copied to computer output devices 116 onto a computer readable medium. The data can also be provided for download in a format readable by a web browser or by a health care provider's system (e.g., for portable use in brining to health care provider).

The setup reports and alerts option 222 provides a user with the capability to generate reports regarding his or her personal health record and alerts a user to possible health related occurrences that may be of interest. For example, alerts are set up by a user to remind them about when they should schedule an appointment (e.g., for preventive health care, for immunizations, or for refilling a prescription), or when they have an appointment. The medical information system also alerts the user in instances where the user is taking drugs that interact with one another or when a test reading is a cause for concern.

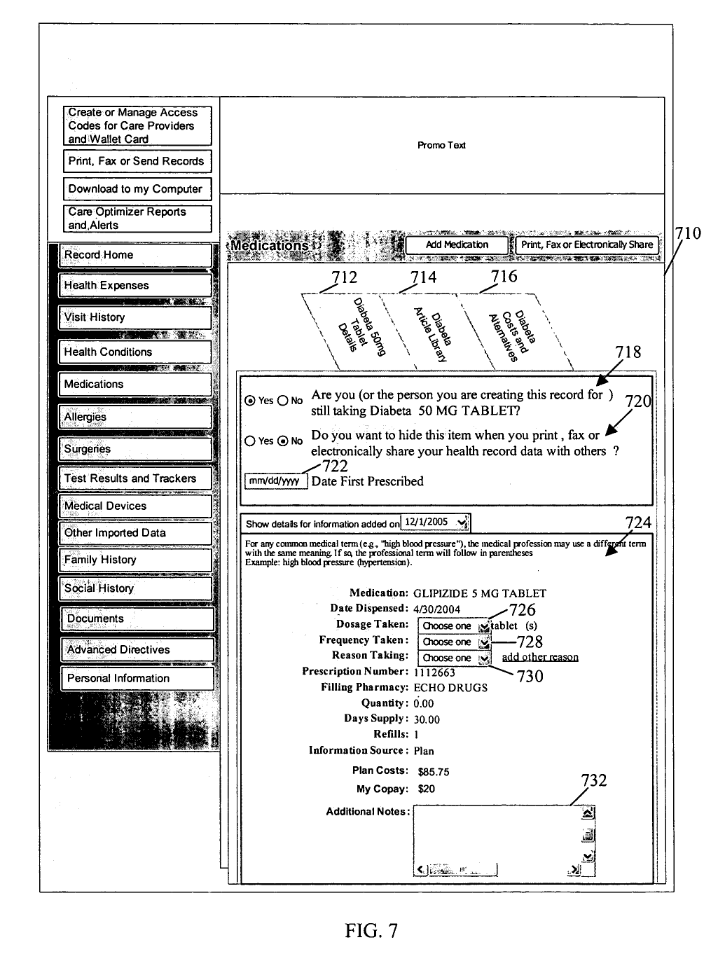

A personal health records section 252 provides information relating to a user's personal health records and comprises viewing options of record home 254, health expenses 256, visit history 258, health conditions 260, findings or symptoms 262, medications 264, allergies 266, surgeries 268, test results and trackers 270, family history 272, social history 274, documents 276, and other emergency data 278. Additional personal health records view options are shown in FIG. 8 and explained below.

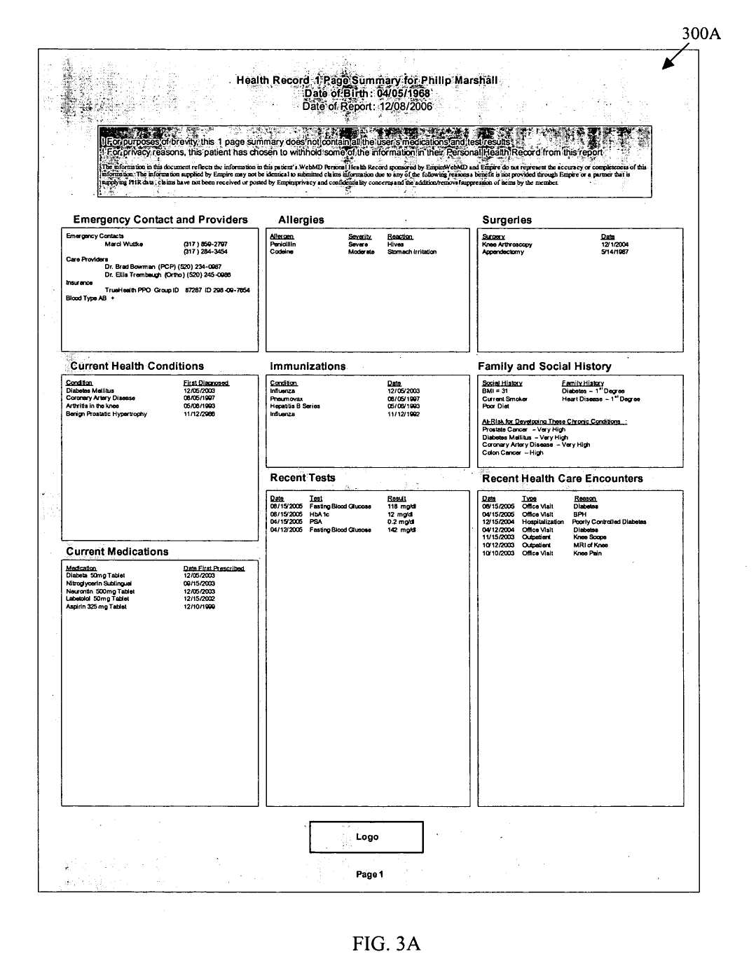

The record home option 254 presents displays of the personal health records information as selected by a user. FIG. 4 depicts a record home screenshot 400. A record home screen 410 is divided into subsections or thumbnails that display personal health records information comprising clinical and financial alerts 412, blood pressure tracker 414, blood sugar tracker 416, health conditions 418, and medications 420. The clinical and financial alerts 412 is hyperlinked to permit the user to move to a full screen display of clinical and financial alert information. The information displayed can be any combination of graphics and text as shown. Trackers such as the blood pressure tracker 414 and blood sugar tracker 416 permit the user to enter text or values to the display graphs. The blood pressure tracker 414 and blood sugar tracker 416 are hyperlinked so that the user can navigate to a tracker screen by clicking on the hyperlink. Health conditions 418 and medications 420 provide information regarding a user's health conditions and medications created from the personal health records.

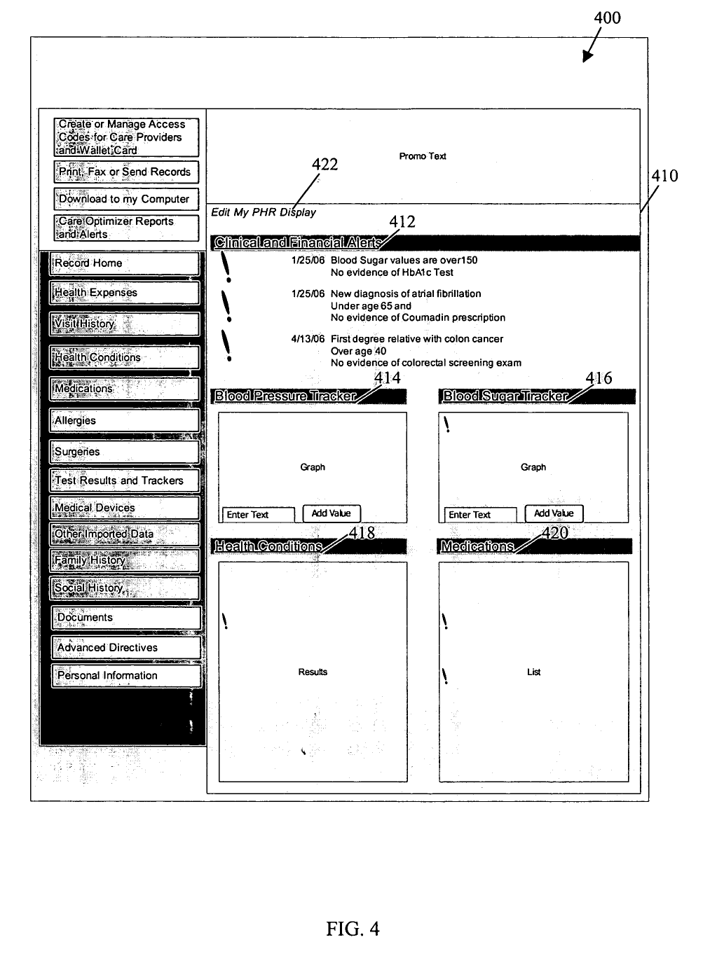

An edit PHR display option 422 moves the user to another screen shown in FIG. 5 where the record home screen 410 display can be edited. FIG. 5 depicts an edit PHR display screen. An edit PHR display screen 510 permits the user to add displays 512, remove displays 514, and rearrange displays 516 shown in record home screen 410. A save changes option 518 remembers the configuration after changes have been made.

The health expenses option 256 permits the user to record and monitor health care expenses such as medications, medical supplies, office visits, hospitalization, surgeries, and tests. This health care expense information can be entered in manually or downloaded from a health care provider, which includes one or more insurance companies. The option assists users in tracking expenses and insurance coverage. Information on medicine, insurance and other options is provided. The visit history option 258 displays information from visits to a health care professional at a health care provider or allows preparation for the visits the user plans to have. Examples of visits include hospitalizations, doctor office visits, outpatient visits, home health visits, and physical therapy visits. A prepare for a visit option on the visit history screen allows the user to complete an interview regarding the reasons for the upcoming visit to assist the health care provider in evaluation and treatment during the visit. A document visit option is also provided for a user to provide details regarding an office visit and can enter information such as the type of visit, the reason for the visit, and the health care provider. Visit information as recommended by a health care professional may also be uploaded from a health care provider.

The health conditions option 260 displays information regarding a user's health as identified by the personal health record. Heath conditions such as diagnoses, conditions, ailments, problems or other significant concerns can be designated as still present or no longer present. A condition is added using a condition to pick from a list of common conditions or search a database for less-common conditions. The display can also direct users to more information regarding their health conditions. The findings or symptoms option 262 displays information from health care providers or health care professionals regarding such things as on-going treatments or on-going diagnosis.

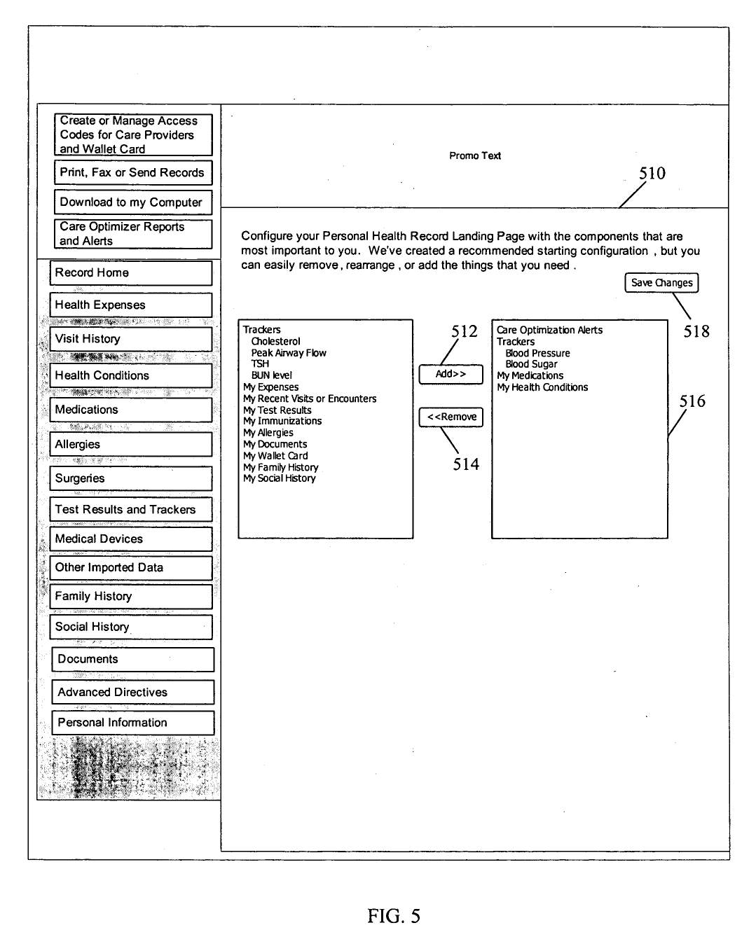

FIG. 6 depicts a screenshot of the medications option 264 display. A medications screen 610 includes information regarding medications 612 in a list. The medications 612 can be sorted according to user preferences using sort option 614. A medication 616 in medications list 612 is hyperlinked to allow the user to edit information regarding the medication. Medications alert 618 notifies the user about possible drug interactions or possible drug complications, such as increased blood pressure when the user suffers from high blood pressure already. Other fields in the medications list 612 are medication expenses 620, current usage 622, and date first prescribed 624. These fields can also be sorted when the sort option is available. A print, fax or electronically share option 626 permits the user to disseminate medication information. An add medication option 628 allows a user to add a new entry to the medications list 612 by choosing from a list of common medications or searching a database for less-common medications. The add medication option 628 also permits a user to fill-in information regarding the medication. Medication information is designated as one being currently used and as one no longer used. Medication information can also be populated from information received by a health care provider (including a pharmacy).

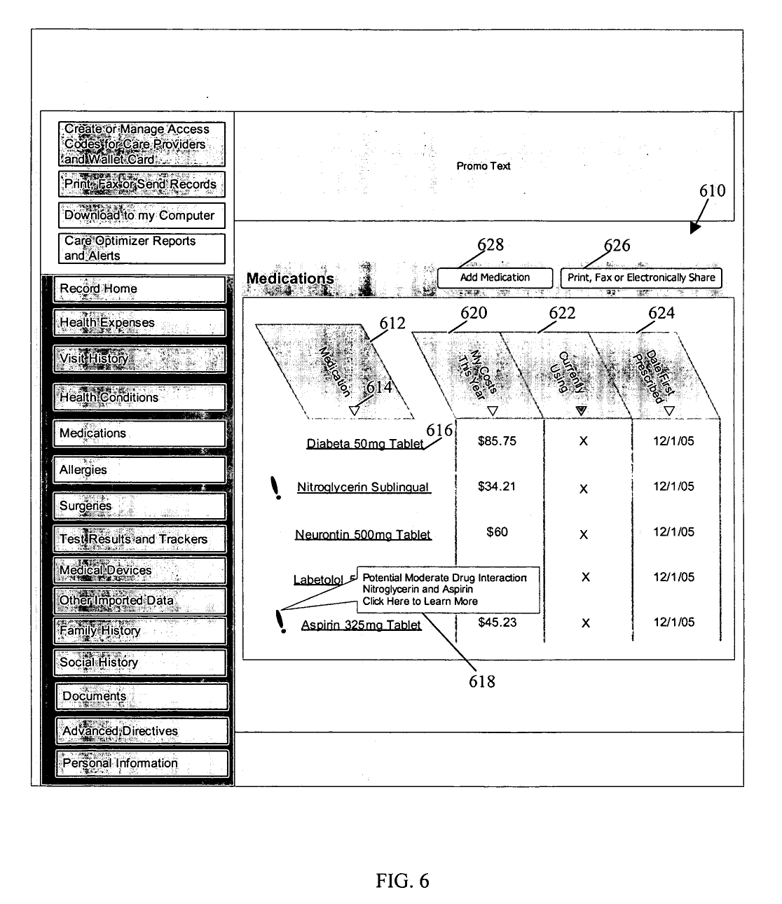

FIG. 7 depicts a screen 710 associated with editing medication. The user navigates to edit medication screen 710 by clicking on the medication 616 (FIG. 6) hyperlink. A details field 712, an article library field 714, and a costs and alternatives field 716 permit the user to navigate through information about a medication 616 (FIG. 6) in screen 710. The details field 712 is currently selected and information regarding the medication is displayed. The user is asked if the medication is still being taken 718 and if the medication should be visible when shared 720. Responses to these questions determine how the medication is displayed to others accessing the personal health records. Text box 722 allows the user to fill-in information regarding the prescription date. Medication detail section 724 provides information regarding medication 616 and allows the user to edit certain information. A dosage pick list 726, a frequency pick list 728, and a reason pick list 730 provide information that can be used to calculate refill alerts and other user prompts. If a reason is not found in the reason pick list 730, a user adds a reason manually or by searching a database. The user can also add notes regarding the medication in notes box 732. Information provided by the health care professional prescribing the medication can be imported into this field when information is uploaded from a pharmacy or health care provider.

The allergies option 266 permits the user to enter or upload information to track allergies. The allergies section of the personal health record includes any substance to which the user may have had an allergic reaction including medication, environmental factors, or food. Add an allergy option allows the user to select from a list or search for an item not on the list in a database. The surgeries option 268 allows the user to enter or upload information regarding surgical operations that were performed on them. This option includes any therapies or treatments that are surgical or invasive in nature, as well as any other surgical operations that have been performed. Some examples of surgeries include abdominal operations such as appendix replacement surgery, orthopedic operations such as knee scope or hip replacement surgery, and even diagnostic procedures such as an open biopsy of a lymph node. An add a surgery option permits a user to select common surgeries from a list or search for items not on the list in a database.

The test results and trackers option 270 permits the user to record test results and to graphically track test results. The test result information is entered manually or be uploaded from a health care provider. FIG. 8 depicts a test results and trackers screen 810. A test list field 812 can be sorted with sort option 814. The test list field 812 includes a test 816 that is hyperlinked to permit a user to edit and view information regarding the test. More than one test result may be grouped into test 816. Clicking on test 816 displays a test screen that may appear similar to 710 (FIG. 7) with a field tab for test result information and a field for articles relating to the test result information. A test cost field 818, a tracking field 820, and date updated field 822 are associated with the test list field 812. Currently tracking field 820 includes a graphical link 824 to a specific tracking screen where test result information is plotted. Alert 826 displays when a test 828 result is of particular interest to the user. The alert 826 may indicate when a result is outside normal or expected ranges. Some tests, such as test 828, are not being tracked by the user. An add test or tracker option 830 permits the user to add a test entry to test field 812. A print, fax, or electronically share option functions in a similar fashion to print, fax, or electronically share option 626 (FIG. 6).

FIG. 8 also depicts other personal health record options. A medical devices option 834 permits the user to monitor medical devices they are currently using and provides access to information such as articles regarding the medical devices. Some examples of medical devices are a heart pump, a prosthetic limb, a pacemaker, cataract implant lenses, and a blood sugar level monitoring machine. An add a device option allows a user to add a device by selecting it from a list or searching a database for additional medical devices. An other imported data option 836 retains information uploaded by a health care provider or other entity that a user may desire to view, but that does not fit into one of the other options for a personal health record.

An advanced directives option 838 provides a repository for health care professional instructions regarding treatment regimens and other health condition information. One type of advanced directive is a living will. A living will comes into effect typically when a person is terminally ill, which is generally when they have less than six months to live. A living will allows a user to specify the type of treatment they would like in certain situations. The advanced directives option 838 provides users with an option to view information pertaining to the regulations and laws governing living wills in their state. Another option provided in the advanced directive option is to create a living will. Templates are provided to assist a user in creating a living will suited to a particular state. The advanced directive option 838 allows a user to store a copy of a living will in the personal health records, store information about where a properly executed living will can be found, or provide guidance on how they would like to be treated. The advanced directives option 838 also permits users to register for organ and tissue donation and can display state specific information regarding organ and tissue donation. A personal information option 840 allows the user to enter information that they may want to share with certain health care professionals.

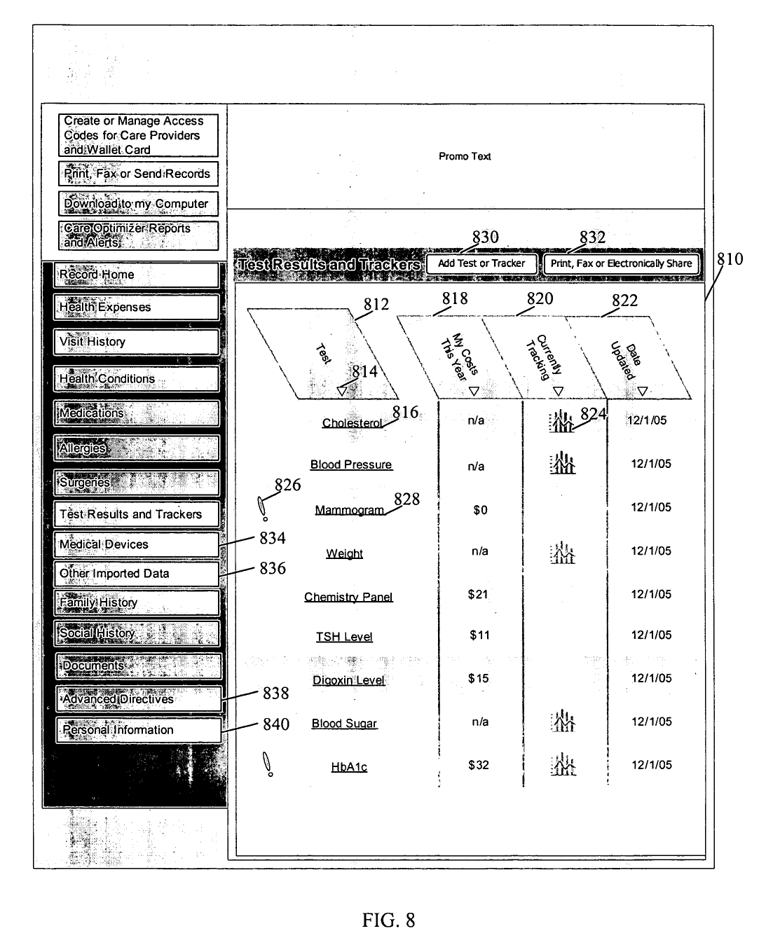

FIG. 9 depicts a screenshot of family history option 272. A family history screen 910 includes health conditions that are present in family members of a user. Health condition field 912 lists the applicable health condition and allows the user to input an additional health condition by selecting enter other option 914. The user can also fill-in what degree(s) of closeness of family members the health condition appears, such as first degree 916, second degree 918, or extended family 920. The user can choose to suppress this information from being shared with providers 922 for each health condition.

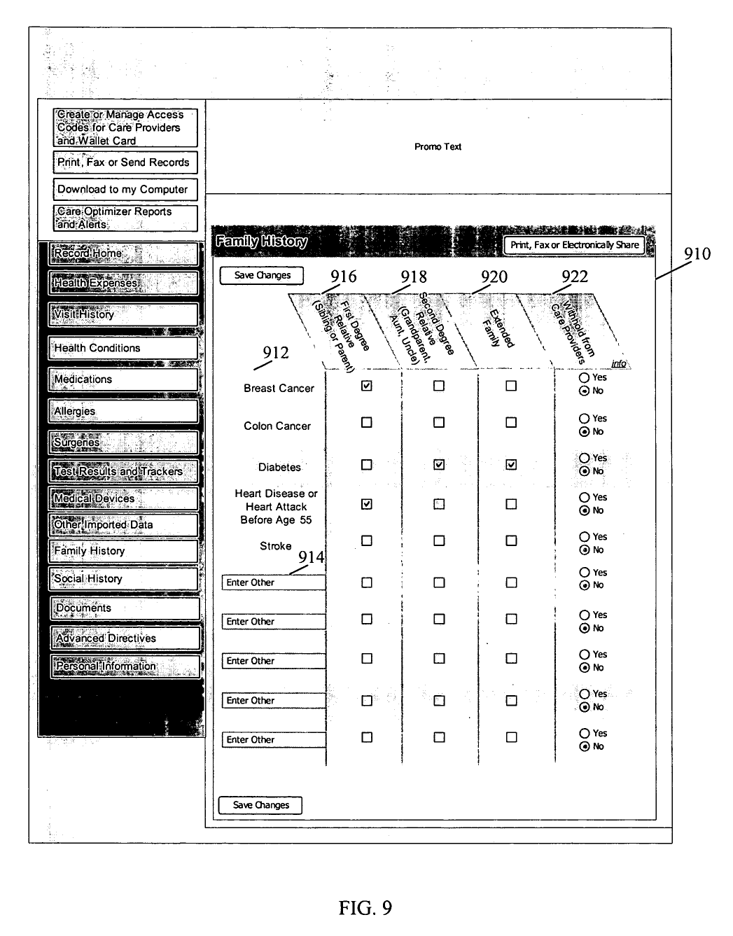

FIG. 10 shows a screenshot of social history option 274 with social history display 1010. A health condition list 1012 lists various conditions the user may engage in or be subject to. The user can identify the validity of the condition through a true field 1014 with the information source being identified in field 1016. An example of an information source is a health questionnaire. The user can also decide whether they would like to share each condition with health care providers 1018. The information provided in FIG. 9 and FIG. 10 is used to calculate at-risk conditions for the user along with the probability of developing the condition.

The documents option 276 (FIG. 2) permits the user to input, view, and store items received from a health care provider such as x-ray images and scanned pages from a user's health care provider file. The other emergency data option 278 allows the user to input, view, and store information such as emergency contacts, care providers, insurance, and blood type.

The above described various aspects of a personal health record including the information that is associated with the health record access ID and how the health record access ID is used to manage access to the personal health record. The health record access ID associated with the personal health record identifies the personal health record for use in accessing, exchanging, and sharing personal health record information with third parties. FIG. 2 and the associated options are one of the interfaces provided for accessing a user's personal health records. Multiple interfaces are provided, as shown in FIG. 11, for an individual to access personal health records. The interface used depends on the individual attempting to access the personal health records and the computer system.

The interfaces shown in FIG. 11 include a public portal 1110, a health care professional access 1112, a private portal 1114, a provider electronic health record 1116, and a provider electronic health record 1118. The public portal 1110 and private portal 1114 allow users to login 1120 with a health record access ID 1122 or login 1124 respectively to their personal health record 1126 and their user profile as depicted in FIGS. 2-10. The public portal login 1120 may ask for a user's username or any other type of identification and a health record access ID. The health record access ID is verified 1122, and if a match is not found or if other information provided does not match the information associated with the health record access ID, the individual is prompted to re-enter the information. The private portal 1114 can be used when a user is already logged into a related system, such as through a virtual private network, and further identification is not necessary. Because the user is already authenticated in private portal 1114, login 1124 can check user authentication when granting access to personal health records 1126. The user may be prompted in login 1124 to enter a subset of information such as a health record access ID or personal information in response to questions. Upon a successful login, the user may be greeted with welcome page or be presented with an option screen such as screenshot 200 of FIG. 2. Whether logging in through a private portal or a public portal, if the health record access ID used as part of the registration process matches an existing health record access ID, along with some validating information such as the challenge/response answers that were previously established, then the user is able to access the existing personal health record, even when that personal health record may have been established under a different login.

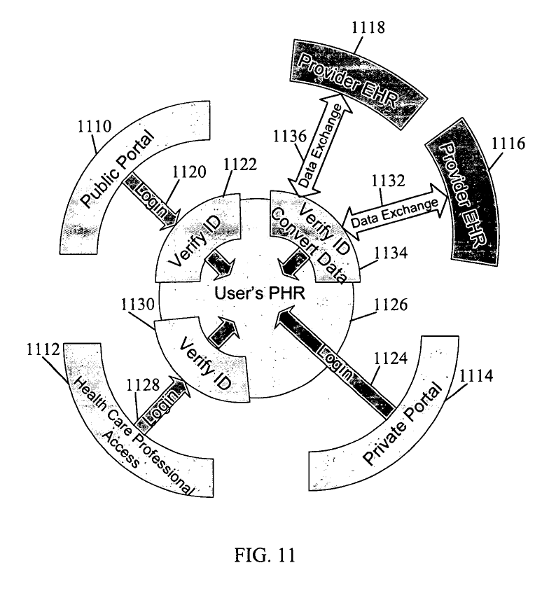

Health care professional access 1112 allows health care professionals such as physicians, pharmacists, physician assistants, medical technicians (e.g., radiologists), and/or nurses to access a patient's personal health records by providing the user's health record access ID in a login 1128, which is verified 1130. FIG. 12 depicts a login webpage 1200 and a health care professional access 1112 (FIG. 11) interface view of personal health record display 1250. The login 1128 (FIG. 11) can include items shown in FIG. 12 such as the user's last name 1210, the user's date of birth 1212, the user's health record access ID 1214, a health care professional's first name 1216 and last name 1218, a facility name 1220, and a security mechanism 1222. The user's last name 1210, date of birth 1212, and health record access ID 1214 are verified 1130 before access to a user's personal health records 1126 (FIG. 11) is granted. The provider's first name 1216 and last name 1218 and facility name 1220 can be logged in the system to allow the user to view who has accessed the personal health records 250 (FIG. 2). The security mechanism 1222 prevents computer programs from trying to access personal health records by guessing login information such as the health record access ID.

After a successful login, a personal health record display 1250 is presented. Personal health record information can be self-reported 1252 through user entry as described above, obtained from health care providers, or determined from other information. One example of determining from other information is health risks section 1254 where a risk level is determined from information such as family and social history. The personal health record display 1250 includes other views such as problems 1258, medications 1260, allergies 1262, tests 1264, immunizations 1266, surgeries 1268, visits 1270, and family and social history 1272.

The medications view 1260 lists the medications the user is taking along with other information such as dosage amount, frequency, and duration. The medication view 1260 can also display how much of a prescribed medication is remaining so a health care professional can know to write a refill prescription, if necessary. The allergies view 1262 lists the allergies experienced by the user. The tests view 1264 displays test results and can provide hyperlinks to accompanying test result documents, such as x-ray images, if available. The immunizations view 1266 lists such information as immunizations received, dates received for the shots, if a booster is needed, and when the booster is needed.

The surgeries view 1268 includes information from surgeries such as the date of surgery, who performed the surgery, and can hyperlink to documents regarding the surgery such as test results or patient instructions, such as physical therapy. The visits view 1270 displays information regarding health care provider visits such as the date, the reason for the visit, any treatments or medications given, any instructions given, and a hyperlink to any applicable documents or test results. The family and social history view 1272 provides information regarding health conditions present in the family and social behaviors in which the user engages. A print option 1274 allows a health care professional to print information from the personal health record.

As shown in FIG. 11, a health care provider can also exchange data with a user's personal health records. The provider electronic health record (EHR) 1116 interface allows data exchange 1132 after verifying a health record access ID 1134 and logging in. However, health care providers use more than one format to store patient data and sometimes the types of data stored electronically vary from one health care provider to another. When a data exchange is desired between a health care provider system and the medical information system of the described embodiment, the data is converted to a format recognizable by the medical information system. The conversion involves parsing the data being exchanged and recognizing the format that the data. Then a conversion table can be used to identify how to change the data into a format recognizable by the medical information system. For example, the medical information system may be setup to recognize different streams of data from different electronic vendors so that a converter can know what to expect in the data stream and translate the information into another format. The provider EHR 1118 interface is an example exchanging data 1136 where the data is converted to a format suitable for the medical information system after verifying the health record access ID 1134 and logging in. The data can be converted using a standard American Society for Testing and Materials (ASTM) converter to a Continuity of Care Record (CCR) document. The CCR is an extensible multimedia language (XML)-based representation of clinical information such as personal health records. A related Health Level 7 (HL7) standard document format is the Continuity of Care Document, or CCD.

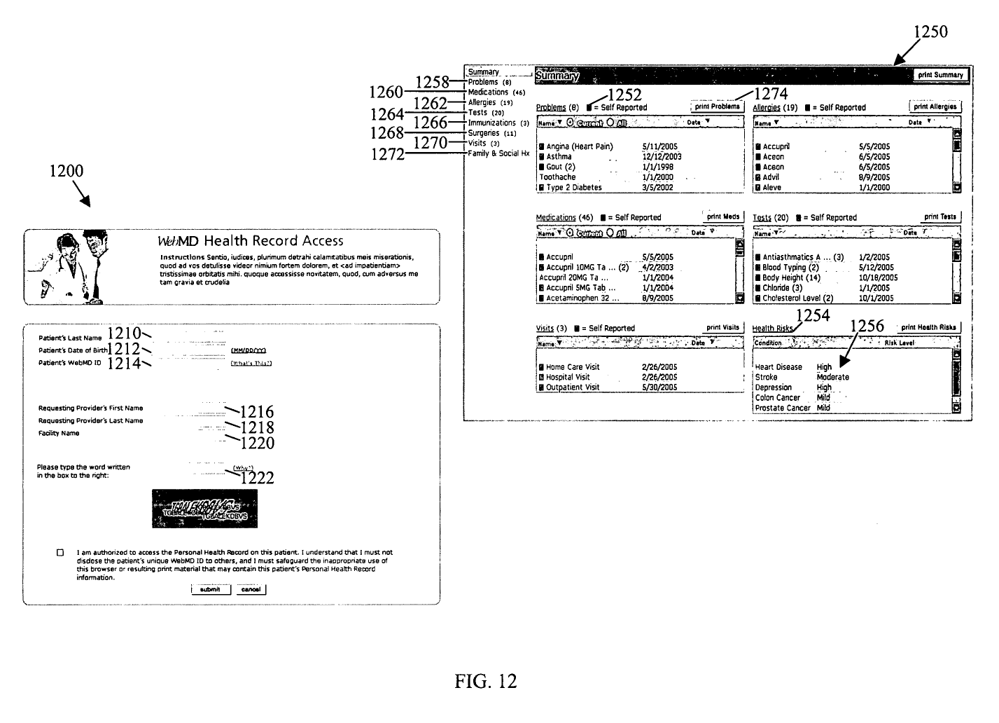

FIG. 13 depicts a data exchange login screen sequence. First, a health care provider is prompted to identify a user 1310. The user's last name 1312, date of birth 1314, and access number 1316 are requested. The information is verified by the medical information system. If a valid match is found, view 1318 echoes back information from the personal health record such as the full name of the user 1320, the user's date of birth 1322, the user's zip code 1324, and the user's health record access ID 1326. The health care provider is also prompted to add their system ID for this user 1328 in text box 1330. The health care provider's system ID can be used in data exchange to identify to which patient the medical information should be associated with.

FIG. 14 depicts data exchange 1400 between health care providers and a server. In this example, the data exchange 1400 includes a server 1410, which is a personal health record (PHR) repository, a first health care provider 1412, and a second health care provider 1414. The first health care provider 1412 initiates an encrypted data request 1416 to server 1410. The encrypted data request 1416 specifies to server 1410 to provide current conditions, medications, and test results only 1418 regarding the user. The server 1410 locates the user's personal health records by using login information including the health record access ID that was provided by the first health care provider 1412 and sends an encrypted data response 1420 to the first health care provider 1412. The encrypted data response 1420 includes a CCR document 1422 with the requested information. The CCR document 1422 can be a data file transferred using a file transfer protocol such as FTP or TCP/IP.

The communication between the first health care provider 1412 and server 1410 is shown in communication flow 1424. The communication flow includes provider 1 1426, which represents first health care provider 1412, and server 1428, which represents server 1410. Provider 1 1426 first sends login information 1430 to server 1428. The server 1428 verifies the login information, which can include the user's last name, health record access ID, and date of birth. A request for a system ID is sent in communication 1432. Some additional user information such as zip code and full name can be sent to provider 1 1426 for verification purposes in communication 1432. Provider 1 1426 sends a data request 1434, which is similar to encrypted data request 1416, and can include the system ID with the request. Server 1428 retrieves the personal health records requested that can be associated with the health record access ID and creates a CCR document. The encrypted data response 1436 is sent to provider 1 1426. The system ID provided by provider 1 1426 can be used by server 1428 in encrypted data response 1436 to identify to which patient the medical information is associated.

A data post or upload 1438 is also shown in FIG. 14. Second health care provider 1414 sends an encrypted data post that includes a CCR document 1440 to server 1410. The server 1410 can use the CCR document 1440 to populate a user's personal health record or can parse the CCR document to update a user's personal health record. If a document other than a CCR document is uploaded to the server with user medical information, the document can be converted by the server to a CCR document and processed accordingly. The communication between the second health care provider 1414 and server 1410 is shown in communication flow 1442. The communication flow 1442 includes a provider 2 1444, which represents second health care provider 1414, and a server 1446, which represents server 1410. In communication flow 1442, Provider 2 1444 sends server 1446 login information 1448. The login information 1448 can include the user's last name, health record access ID, and date of birth. The server 1446 verifies the login information and sends a message 1450 to provider 2 1444 verifying login. The message 1450 may also request a system ID. Provider 2 1444 sends an encrypted data response document 1452 to server 1446 and can include the system ID, if requested. The server 1446 can populate the user's personal health record or can update the user's personal health record with the encrypted data response 1452.

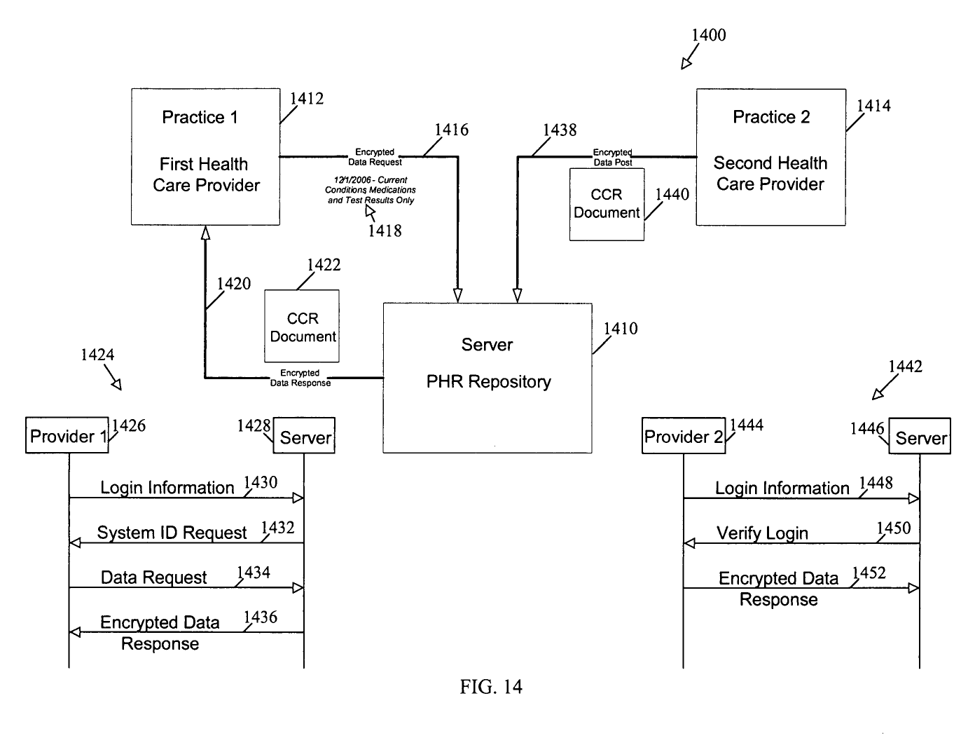

FIG. 15 depicts a process diagram 1500 for exchanging data through a health record access ID with a regional organization such as a Regional Health Information Organization. The process diagram begins with a user registering information through a public or private portal at 1510. The user is asked to provide information such as his or her name, date of birth, zip code, email address, and gender to register at 1510. The user is prompted to create a health record access ID at 1512 to provide access to the personal health records. The user can manually select the health record access ID conforming to certain rules regarding available characters and minimum length, or can have one automatically generated. The user can also setup a profile by entering in health information manually and/or setting configuration options 1514. The user provides a selected health record access ID to a health care provider 1516. The user may choose to have the medical information system generate a health record access ID wallet card (see FIG. 2A) to share with health care providers. The health record access ID may be used by the Regional Health Information Organization as part of a Record Locator Service, which uses the ID as part of a statistical identity matching process to allow data to be aggregated from across different systems.

The health care provider navigates to the web-based interface and provides login information including the health record access ID at 1518. During login, the health care provider is asked to provide other personal information about the user to authenticate. The other personal information is information that a health care provider would have access to for one of their patients. Such information is user's last name, their date of birth, and/or their zip code for example. At 1520, the health care provider is asked to provide the Regional Health Information Organization (RHIO) solution's ID for the user, which the health provider would typically have. The health record access ID and RHIO ID are communicated to the RHIO at 1522 so that the RHIO can include the health record access ID as part of its database (e.g., a master person index). Data can be exchanged between the RHIO and the server where the personal health records are located (e.g., server 1410 (FIG. 14)) using the health record access ID at 1524.

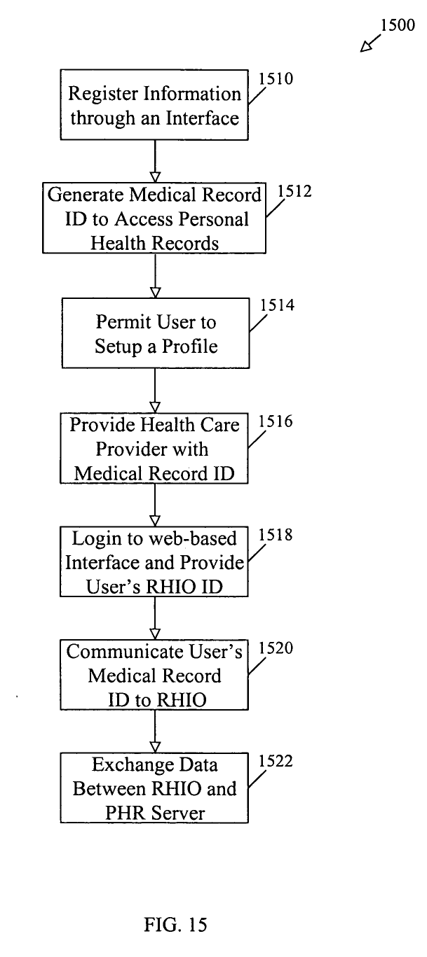

FIG. 16 shows a process diagram 1600 for receiving a data exchange to update a user's personal health records. A user provides a health record access ID to a health care provider at 1610. The user creates this health record access ID by registering through an interface. The health record access ID can be specific to a particular health care provider, or the user can use the health record access ID for more than one health care provider. The health care provider logs in through a web-based interface providing the health record access ID and shared personal information about the user at 1612. If the health record access ID and shared personal information match, verification is sent to the health care provider and the health care provider is prompted to enter the ID with which the health care provider identifies the user at 1614. The health care provider uploads medical information to the server where the personal health records of the user are stored at 1616. This medical information is parsed by the server and compared against the personal health records of the user to determine what is new information and what information, if any, is to be updated at 1618. The server then updates the personal health record information with the received medical information at 1620. For example, this can occur when a user walks into a doctor's office. The user can provide the doctor's office with the health record access ID, which is entered into an access portal to exchange and share medical information.

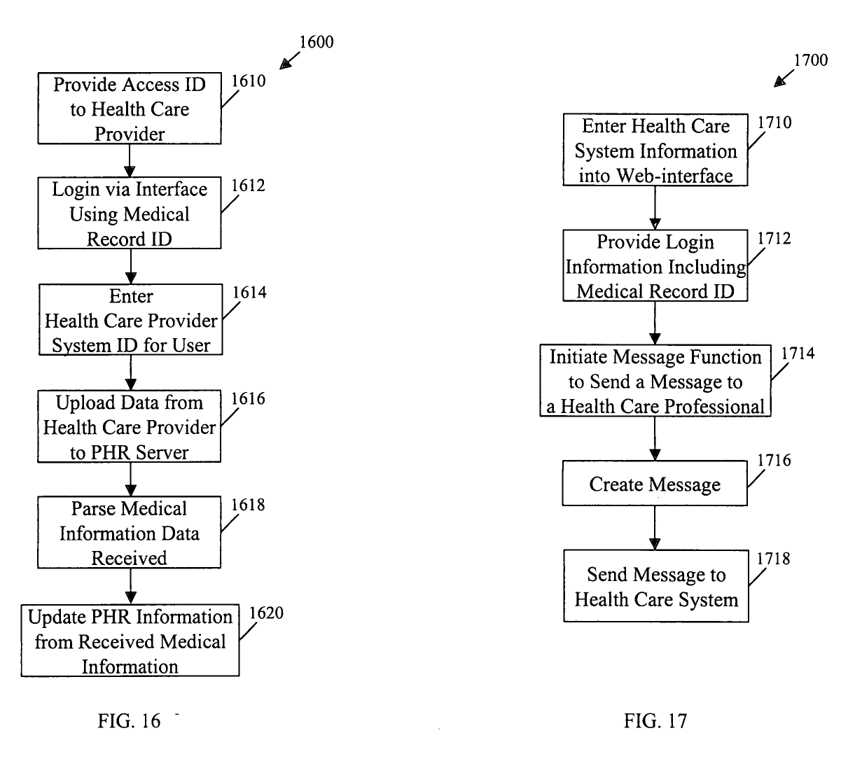

FIG. 17 depicts a diagram 1700 for using a message service. The messaging service allows a user to contact a health care professional to ask questions for example. The messaging service can use a similar data exchange method as the one shown in FIG. 14. The secure message can be packaged into a document, such as a CCR document, and uploaded to the health care providers system. Once received by the health care provider's system, the document is sent to the health care professional's messaging function provided by the health care provider's system. To enable the health care provider's system to recognize the message, the health care provider enters information into the user's personal health record profile at 1710. The health care provider can access a portion of the personal health record profile through a web-based interface. The information that can be provided is the health care provider's unique system ID for the user, and a health care professional's secure messaging ID or system ID. The user logs on through a web-based interface to a personal health records display by providing a health record access ID and other information at 1712. The user initiates a message function at 1714 to send a message to a health care professional. The health care professional is chosen from a list of individuals who have been setup by the health care provider at 1712. The user creates a message by typing into an email like interface provided by the messaging function at 1716. The user chooses send at 1718 to have the messaging function securely route the message to the health care professional.

The personal health record data of multiple users can be provided by the medical information system in a read-only format to third parties, with the consent of the users. This may be used to update a health insurer's database with information from employees that participate in the company's health insurance plan. Another use for the personal health records is for public health organizations to track trends and/or identify hot spots for certain diseases or afflictions from portions of the data that is provided anonymously to public health organization for aggregation and analysis. For example, symptoms can be monitored to detect the possibility of an outbreak. Users may also allow analytics companies to review medical information from a user's personal health records by the health record access ID to find users that match criteria for selection for medical trials or other opportunities. The users can be notified through the medical information system's secure messaging function so the anonymity of the user is preserved. The analytic companies may also aggregate the data to provide research products from the medical data. Users may also allow companies, such as medical device manufacturers and pharmaceutical companies, to access their medical information so that companies can provide incentives to the users to try their products or provide incentives for advertising opportunities regarding their products.

The medical information system provides users with the ability to authorize access for a health care provider, a health care professional, or even a third party to add notations to the user's personal health record. The user can provide access to the personal health record through the access ID. The user can also allow other health care providers or health care professionals to view and download the notations to the health care provider's electronic health records (EHR) system through the access ID. Authorizing the addition of notations allows the user's personal health record to be more detailed or complete. An example of a notation is a health care professional adding notes to the user's personal health record after a visit to provide an update on the user's condition or on a medical condition.

Referring to FIG. 1, the output devices 116 and 126 include devices such as printers, monitors, and removable storage media. The input devices 118 and 128 can include devices such as a keyboard, a mouse, and removable storage media. The Internet 130 can include other computers, servers, and routers that store information and relay information along to its destination. The health record access ID can be given to any third party, which includes health care providers, to grant access to personal health records. For example, the health record access ID can be given to a parent's adult child to monitor the parent's health. Also, medical information stored on a health care provider's computer can be stored on a remote server and accessed through a network or stored in a distributed fashion across a system. The computer used in exchanging data at a health care provider may not store medical information on its storage device, but rather run software that has access to patient medical information in some embodiments. Further, other document types can be used with the data exchange and with the storing of personal health records, such as HL7, or any other applicable format. There can also be more than one security mechanism (e.g., security mechanism 1222 (FIG. 12)) to provide more security when an individual attempts to access a user's personal health records. In some embodiments, access through private portal 1114 (FIG. 11) is the only way to edit the profile of personal health records 1126. The portals can also be used to allow family members or other caregivers to access personal health record information for a user.

A person health record can include a wide range of health related information such as, without limitation, demographic information (e.g., date of birth, gender, name, and zip code); insurance coverage information; care provider information; emergency contact information; personal descriptive information (e.g., eye color, height, weight, and hair color); health care encounters; health risks, health status, development status, and functional status; health conditions, problems, concerns or diagnoses; clinical symptoms, signs, or findings; prescription medications, herbal remedies, or over-the-counter medications; biometric, laboratory, radiology, and other test data; images, including radiology, cardiology, and other images; documents, such as living wills and advanced directives; preferences for receiving health care services; surgeries; immunizations; allergies; implants or medical devices; topics of interest; alerts, messages, or reports based upon other personal health record information; messages to/from health care providers or health care professionals; and health expense information, including financial data from claims, Health Savings Account (HAS) account status and deductible status. The personal information requested at login by the interface may include other personal information that a health care provider would have access to without limitation. Also the questions regarding personal information chosen by the user in registration can be used in conjunction with the health record access ID to provide access to third parties.

Referring to FIG. 13, other information can be echoed back to the health care provider to verify the correct patient was selected. In certain embodiments, the messaging securely option provided to users can send to a web-interface accessible to health care providers by entering their system ID. The health record access ID can be provided in FIG. 15 by the health care provider to the RHIO, and then the server 1410 can communicate with the RHIO. The verification 1130 can also include an allow list that checks if a provider has been granted access to view personal health records 1126.

Other embodiments are within the scope of the following claims.

1. A method for sharing and exchanging medical information in a personal health record comprising:
receiving registration information from a user;
in response to receiving registration information from the user, creating a unique health record access ID;
associating the unique health record access ID with the personal health record so that the unique health record access ID identifies the personal health record;
through a network interface receiving from a third party the unique health record access ID and at least one piece of personal information identifying the user; and
providing access to the personal health record that is identified by the unique health record access ID.

2. The method of claim 1, wherein a unique alpha-numeric health record access ID is created.

3. The method of claim 1, wherein the at least one piece of personal information is a date of birth.

4. The method of claim 1, wherein the access is exchanging medical information from a health care provider to the personal health records associated with the unique health record access ID.

5. The method of claim 4, further comprising:
parsing medical information received from a health care system; and
updating the personal health records from the medical information received.

6. The method of claim 1, further comprising converting received medical information from a first format to a second format.

7. The method of claim 1, further comprising disabling the unique health record access ID so access to the personal health record is prevented.

8. The method of claim 1, further comprising re-enabling the unique health record access ID so that the health record access ID provides access to the personal health record.

9. The method of claim 1, further comprising:
providing access to the personal health record to the third party to add notations to the personal health record; and
providing access to a second third party to view the notations and download the notations into the second third party's electronic health records system.

10. A system for sharing and exchanging medical information in a personal health record comprising:
a web-based interface receiving registration information from a user;
a server accessible through the web-based interface and coupled to at least one storage where personal health records reside;
a CPU residing in the server in communication with the web-based interface that in response to receiving registration information from the user, creates a unique health record access ID and associates the unique health record access ID with the personal health record so that the unique health record access ID identifies the personal health record; and
the web-based interface receiving from a third party the unique health record access ID and at least one piece of personal information identifying the user and providing access to the personal health record that is identified by the unique health record access ID.

11. The system of claim 10, wherein the CPU creates a unique alpha-numeric health record access ID.

12. The system of claim 10, wherein the web-based interface receives a date of birth as the at least one piece of personal information identifying the user.

13. The system of claim 10, further comprising the web-based interface receives medical information from a health care provider for populating the personal health record.

14. The system of claim 10, further comprising:
the CPU parsing medical information received from a health care system; and
the CPU updating the personal health records stored on the server with the medical information received.

15. The system of claim 10, further comprising the CPU converting received medical information from a first format to a second format.

16. The method of claim 10, further comprising the web-based interface disabling the unique health record access ID so access to the personal health record is prevented.

17. The method of claim 10, further comprising the web-based interface re-enabling the unique health record access ID so that the health record access ID provides access to the personal health record.

18. A system for sharing and exchanging medical information in a personal health record comprising:
a means for providing an interface that receives registration information from a user;
a means for providing a server accessible through the means for providing an interface and coupled to at least one storage where personal health records reside;
a processing means residing in the means for providing a server in communication with the means for providing an interface that in response to receiving registration information from the user, creates a unique health record access ID and associates the unique health record access ID with the personal health record so that the unique health record access ID identifies the personal health record; and
the means for providing an interface receiving from a third party the unique health record access ID and at least one piece of personal information identifying the user, and providing access to the personal health record that is identified by the unique health record access ID.

19. The system of claim 18, wherein the means for providing an interface provides an option to automatically generate a unique alpha-numeric health record access ID.

20. The system of claim 18, wherein the means for providing an interface receives a date of birth as the at least one piece of personal information identifying the user.

21. The system of claim 18, further comprising the means for providing an interface receiving medical information from a health care provider for populating the personal health record.

22. The system of claim 18, further comprising:
the processing means parsing medical information received from a health care system; and
the processing means updating the personal health records stored on the means for providing a server with the medical information received.

23. The system of claim 18, further comprising the processing means converting received medical information from a first format to a second format.

24. A method for communicating between a user and a health care professional comprising:
requesting login information including a unique health record access ID;
initiating a message function; and
sending a secure message to a health care provider for routing to a health care professional in the health care provider's system.

25. The method of claim 24, wherein the secure message is packaged into a document and uploaded to the health care providers system.

26. The method of claim 24 further comprising:
requesting a health care provider's unique system ID for the user; and
sending the secure message to the health care provider with the health care provider's unique system ID for the user.

27. A method for sharing and exchanging medical information from a plurality of users comprising:
receiving from any one user in the plurality of users registration information;
in response to receiving registration information from the any one user in the plurality of users, creating a unique health record access ID;
associating the unique health record access ID with a personal health record of the any one user in the plurality of users so that the unique health record access ID identifies the personal health record in a plurality of personal health records;
through a network interface receiving from a third party the unique health record access ID and at least one piece of personal information identifying the any one user in the plurality of users; and
providing access to the personal health record that is identified by the unique health record access ID.

28. The method of claim 27, further comprising providing personal health record data of at least one of the plurality of users in a read-only format to a third party.
